(19) United States
(12) Patent Application Publication
(10) Pub. No.: US 2023/0077426 A1
(43) Pub. Date: Mar. 16, 2023

(54) MESSAGE PROCESSING METHOD, APPARATUS AND DEVICE, AND STORAGE MEDIUM

(71) Applicant: SENSETIME INTERNATIONAL PTE. LTD., Singapore (SG)

(72) Inventors: Bing SUN, Singapore (SG); Xinxin Wang, Singapore (SG)

(21) Appl. No.: 17/489,144

(22) Filed: Sep. 29, 2021

Related U.S. Application Data
(63) Continuation of application No. PCT/IB2021/058761, filed on Sep. 26, 2021.

(30) Foreign Application Priority Data
Sep. 16, 2021 (SG) 102021 10223Q

(51) Int. Cl. H04L 29/08; H04L 12/24; A63F 13/79

(52) U.S. Cl. CPC H04L 67/2809; H04L 41/0803; A63F 13/79

(57) ABSTRACT

Provided are a message processing method and apparatus, device, and a storage medium. The method includes that: a plurality of messages generated by a Data Analyzing System (DAS) are acquired through at least one message queue, the DAS being used for analyzing scene data; the plurality of messages are filtered based on a preset configuration file to obtain at least one filtered message, the configuration file being used for filtering out a message, which does not need to be forwarded to a management system, in the plurality of messages based on at least one attribute dimension of the message and an interception parameter corresponding to each attribute dimension; a target channel corresponding to each filtered message is determined in at least two connecting channels; and each filtered message is forwarded to the management system through the target channel corresponding to each message.

### CROSS-REFERENCE TO RELATED APPLICATION(S)

The application is continuation of international application PCT/IB2021/058761 filed on 26 Sep. 2021, which claims priority to Singaporean patent application No. 10202110223Q filed with IPOS on 16 Sep. 2021. The contents of international application PCT/IB2021/058761 and Singaporean patent application No. 10202110223Q are incorporated herein by reference in their entireties.

### TECHNICAL FIELD

Embodiments of the disclosure relate to the field of data processing, and more particularly to a message processing method, apparatus and device, and a storage medium.

### BACKGROUND

In a game place, in order to guarantee fairness of game, it is necessary to analyze scene data such as behaviors of players and game controllers and placing positions of game props in the game place and judge whether preset related rules are met or not. Under a circumstance that the related rules are not met, a warning message needs to be generated and forwarded to a management system.

Traditionally, a Data Analyzing System (DAS) that analyzes the scene data generates related messages, and then sends the related messages to the management system that processes the warning message. The management system needs to process and display all the messages generated by the DAS, so the management system has great operating pressure.

### SUMMARY

The embodiments of the disclosure provide a message processing method, apparatus and device, and a storage medium.

In a first aspect, a message processing method is provided. The message processing method includes that: a plurality of messages generated by a DAS are acquired through at least one message queue, the DAS being used for analyzing scene data to generate the plurality of messages; the plurality of messages are filtered based on a preset configuration file to obtain at least one filtered message, the configuration file being used for filtering out a message, which does not need to be forwarded to a management system, in the plurality of messages based on at least one attribute dimension of the message and an interception parameter corresponding to each attribute dimension; a target channel corresponding to each filtered message is determined in at least two connecting channels; and each filtered message is forwarded to the management system through the target channel corresponding to each message, enabling the management system to process the message transmitted by each target channel based on a message processing strategy corresponding to each target channel.

In some embodiments, the message processing method is applied to a message broker component, and the message broker component is configured to filter the plurality of messages generated by the DAS and forward the filtered messages to the management system. The DAS includes a plurality of function modules. Each function module is configured to use an analyzing method corresponding to the each function module to analyze the scene data collected in the game place to generate a corresponding message. The message is used for indicating whether there is an abnormal event in the game place or not. The management system is configured to display the filtered messages forwarded by the message broker component to a game controller.

In some embodiments, the DAS further includes a camera component arranged in the game place, the camera component being configured to collect the scene data in the game place.

In some embodiments, that the plurality of messages are filtered based on the preset configuration file to obtain at least one filtered message includes that: the configuration file is parsed to obtain an interception parameter of at least one attribute dimension; each message is parsed to determine attribute information carried by each message; and the plurality of messages are filtered based on the interception parameter of at least one attribute dimension and the attribute information of each message to obtain the at least one filtered message.

In some embodiments, the interception parameter of at least one attribute dimension includes the interception parameter of a function module dimension corresponding to the message. That the plurality of messages are filtered based on the interception parameter of at least one attribute dimension and the attribute information of each message to obtain the at least one filtered message includes that: a function module to be intercepted in at least one function module of the DAS is determined based on the interception parameter of the function module dimension; the function module corresponding to each message is determined according to the attribute information of each message; and the message corresponding to the function module which is the function module to be intercepted is removed from the plurality of messages to obtain the at least one filtered message.

In some embodiments, the interception parameter of at least one attribute dimension includes the interception parameter of a message identifier dimension. That the plurality of messages are filtered based on the interception parameter of at least one attribute dimension and the attribute information of each message to obtain the at least one filtered message includes that: a message identifier to be intercepted in a plurality of message identifiers corresponding to the plurality of messages is determined based on the interception parameter of the message identifier dimension; a message identifier corresponding to each message is determined according to the attribute information of each message; and the message whose message identifier is the message identifier to be intercepted is removed from the plurality of messages to obtain the at least one filtered message.

Through the above embodiments of the disclosure, after the message broker component acquires a plurality of messages from the DAS, the plurality of messages may be filtered from different attribute dimensions based on different actual scenes and configuration files. For example, in a scene where the manager needs to pay attention to the messages of a warning type and/or a non-warning type, the messages may be filtered from a message type dimension, and the message broker component may be made to forward only the messages of the message type that the manager pays attention to. In a scene where the manager needs to select some display modes from display screen, indicator light display and audio display, the messages may be filtered from the message identifier dimension, and the message broker component may be made to forward the corresponding message to the management system based on the requirements of display mode. In the process that the manager develops and debugs some function modules, to prevent a generated error message from being forwarded to the management system, the messages may be filtered from the function module dimension corresponding to the messages. Therefore, through the method disclosed in the above embodiments, not only may a plurality of messages generated by the DAS be effectively filtered, but also the messages with different attribute information may be filtered for different scenes, thereby expanding the application scope of the embodiments of the disclosure.

In some embodiments, the method further includes that: a triggering event for updating the configuration file is received; and in response to the triggering event, a configuration file in a publishing platform is acquired as the preset configuration file. The triggering event includes at least one of the followings: the message broker component is started; or the publishing platform receives a configuration instruction of a user for the configuration file.

Through the above embodiments of the disclosure, the message broker component may acquire, in response to the triggering event for updating the configuration file, the configuration file in the publishing platform as the preset configuration file. Therefore, a filtering rule of the message broker component for the plurality of messages generated by the DAS may be changed as user needs change, which not only improves the flexibility of a message filtering scheme, but also improves the quality of the messages received by the management system.

In some embodiments, the method further includes that: a plurality of test messages generated by the DAS for sample scene data are acquired through the at least one message queue; the plurality of test messages are compared with a standard message corresponding to the sample scene data to determine at least one error message; and the configuration file is generated based on the at least one error message.

In some embodiments, that the configuration file is generated based on the at least one error message includes that: the at least one error message is parsed to obtain the attribute information of each error message, the attribute information of the error message including at least one of the followings: a function module or a message identifier corresponding to the error message; and the configuration file is generated based on the attribute information of each error message, the configuration file including an interception parameter of at least one attribute dimension.

Through the above embodiments of the disclosure, the message broker component may generate the test messages for the sample scene data based on the DAS, count the attribute information of the error message generated by the DAS, and then generate the corresponding configuration file based on the attribute information of the error message. Therefore, the generated configuration file may adaptively filter the error message generated by the DAS, which improves message passing efficiency.

In some embodiments, the DAS includes a plurality of function modules, and different function modules analyze the scene data through different analyzing methods to generate the message corresponding to at least one topic. The operation that the plurality of messages generated by the DAS are acquired through at least one message queue includes that: for each message queue of the at least one message queue, a target topic corresponding to the message queue is acquired, and the message corresponding to the target topic among the plurality of messages is stored in the message queue.

In some embodiments, the operation that the plurality of messages generated by the DAS are pulled from the at least one message queue includes that: at least one topic to be pulled is determined based on the configuration file; and the message is pulled from the message queue corresponding to each topic to be pulled based on the at least one topic to be pulled.

Through the above embodiments of the disclosure, the service type of the message that the manager currently needs to acquire may be determined through at least one topic to be pulled set in the configuration file, and then only the message of the service type that the manager needs may be pulled in the process of pulling messages. In this way, not only may the plurality of messages generated by the DAS be filtered from the dimension of service type, but also the process of the message broker component parsing the pulled messages may be saved, thereby reducing the system calculation pressure of the message broker component.

In a second aspect, a message processing system is provided, which includes a DAS, a message broker component and a management system. The DAS is configured to analyze scene data to generate a plurality of messages, and send the plurality of messages to the message broker component. The message broker component is configured to acquire the plurality of messages through at least one message queue, filter the plurality of messages based on a preset configuration file to obtain at least one filtered message, the configuration file being used for filtering out a message, which does not need to be forwarded to the management system, in the plurality of messages based on an attribute dimension of the message and an interception parameter corresponding to each attribute dimension, determine a target channel corresponding to each filtered message in at least two connecting channels, and forward each message to the management system through the target channel corresponding to each message. The management system is configured to process the message transmitted by each target channel based on a message processing strategy corresponding to each target channel.

In a third aspect, a message processing apparatus is provided, which includes: an acquisition unit, a filtering unit, a determination unit, and a forwarding unit. The acquisition unit is configured to acquire a plurality of messages generated by a DAS through at least one message queue, the DAS being used for analyzing scene data to generate the plurality of messages. The filtering unit is configured to filter the plurality of messages based on a preset configuration file to obtain at least one filtered message, the configuration file being used for filtering out a message, which does not need to be forwarded to a management system, in the plurality of messages based on an attribute dimension of the message and an interception parameter corresponding to each attribute dimension. The determination unit is configured to determine a target channel corresponding to each message in at least two connecting channels. The forwarding unit is configured to forward each message to the management system through the target channel corresponding to each message, so that the management system processes the message transmitted by each target channel based on a message processing strategy corresponding to each target channel.

In a fourth aspect, a message processing device is provided, which includes: a memory and a processor. The memory stores a computer program capable of running on the processor, and the processor implements the steps of the above-mentioned method when executing the computer program.

In a fifth aspect, a computer storage medium is provided, which stores one or more computer programs. The one or more computer programs, when executed by one or more processors, may implement the steps of the above-mentioned method.

In the embodiments of the disclosure, the plurality of messages generated by the DAS is received through at least one message queue. Compared with a scheme that the DAS is directly communicated with the management system in the related art, decoupling among the subsystems of a message processing system may be realized. In a development process of the DAS or the management system, it is unnecessary to modify the other system when one of the systems is changed, such that the expandability of the system is improved while the maintenance cost of the system is lowered. Further, before the plurality of messages generated by the DAS are forwarded to the management system, the messages that do not need to be forwarded to the management system are filtered using the preset configuration files, so the message processing efficiency of the management system may be improved while system transmission bandwidth is reduced, and the validity of the information obtained by the managers through the management system may also be improved.

### BRIEF DESCRIPTION OF THE DRAWINGS

FIG. 1 is a structural schematic diagram of a message processing system provided by an embodiment of the disclosure.

FIG. 2 is a flowchart of a message processing method provided by an embodiment of the disclosure.

FIG. 3 is a flowchart of a message processing method provided by an embodiment of the disclosure.

FIG. 4 is a flowchart of a message processing method provided by an embodiment of the disclosure.

FIG. 5 is a flowchart of a message processing method provided by an embodiment of the disclosure.

FIG. 6 is a flowchart of a message processing method provided by an embodiment of the disclosure.

FIG. 7 is a flowchart of a message processing method provided by another embodiment of the disclosure.

FIG. 8 is a schematic diagram of system architecture of a message processing system provided by an embodiment of the disclosure.

FIG. 9 is a composition structure diagram of a message processing apparatus provided by an embodiment of the disclosure.

FIG. 10 is a schematic diagram of a hardware entity of a message processing device provided by an embodiment of the disclosure.

### DETAILED DESCRIPTION

The following specific embodiments may be combined. The same or similar concepts or processes will not be elaborated in some embodiments.

It is to be noted that, in the embodiments of the disclosure, “first”, “second” and the like are adopted to distinguish similar objects and not intended to describe a target sequence or order. In addition, the embodiments of the disclosure may be freely combined without conflicts.

The message processing method provided in the embodiments of the disclosure may be applied to a casino scene. In the casino scene, the player mentioned anywhere in the embodiments of the disclosure may include a player or a banker, the game controller mentioned anywhere in the embodiments of the disclosure may refer to a dealer, the game table mentioned anywhere in the embodiments of the disclosure may refer to a gambling table, the game currency mentioned anywhere in the embodiments of the disclosure may include chip, the placement region mentioned anywhere in the embodiments of the disclosure may refer to an anteing region or a betting region on the game table. The management system mentioned anywhere in the embodiments of the disclosure may refer to a Casinos Management System (CMS).

In some implementation modes, the game on the game table may be Baccarat. In some other implementation modes, the game on the game table may be other games, such as Zhajinhua, Niuniu, Fishing Joy, Texas Poker, one-arm bandit, show-hand, PaiGow or Fight the landlord. The game type is not limited in the embodiments of the disclosure. The game on the game table may be a card game or a non-card game.

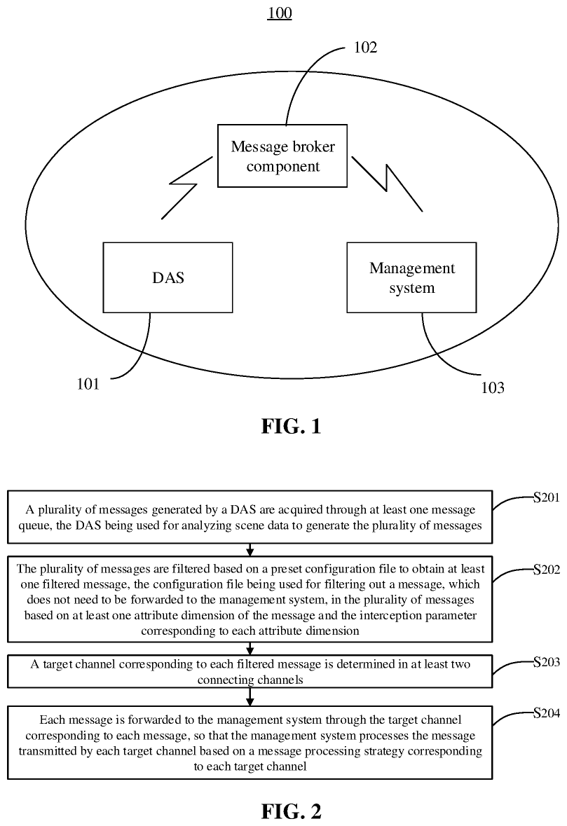

FIG. 1 is a structural schematic diagram of a message processing system provided by an embodiment of the disclosure. As shown in FIG. 1, the system 100 may include a DAS 101, a message broker component 102 and a management system 103.

In some implementation modes, the DAS 101 may include a camera component and an analyzing device. The camera component may be a bird view camera component. The camera component may include a plurality of cameras, for example, the camera component may include two cameras, three cameras, four cameras and etc. The plurality of cameras may be arranged above a game table, such that each camera may shoot the one game table, or, the plurality of cameras may be arranged above a plurality of game tables, such that each camera may shoot each game table in the plurality of game tables. In some other implementation modes, the camera component may include one camera. The camera may be arranged above one game table, or, the camera may be arranged above the plurality of game tables. The analyzing device may only correspond to one camera component. The analyzing device may further correspond to a plurality of camera components, for example, the plurality of camera components corresponding to the analyzing device may be camera components configured to shoot the game tables in one or more game places, or, the plurality of camera components corresponding to the analyzing device may be camera components configured to shoot the game tables in a part of regions of one game place. The part of regions may be common regions, Very Important Person (VIP) regions, etc.

In some implementation modes, it is necessary to arrange the camera components in the DAS 101 in the game place to collect the scene data in the current game place. The scene data may include action data of figure objects (game controllers and/or players) and game prop data in the game tables. The analyzing device in the DAS 101 may be arranged in the game place. For example, the analyzing device may be connected with a server in the game place. In some other implementation modes, the analyzing device in the DAS 101 may further be arranged at a cloud.

The camera assembly may be in communication connection with the analyzing device. In some implementation modes, the camera components may shoot real-time images periodically or aperiodically and send the shot real-time images to the analyzing device. For example, under a circumstance that the camera component includes the plurality of cameras, the plurality of cameras may short the real-time images at every target interval and send the shot real-time images to the analyzing device. The plurality of cameras may shoot the real-time images at the same time or at different times. In some other implementation modes, the camera components may shoot real-time videos and send the real-time videos to the analyzing device. For example, under a circumstance that the camera component includes the plurality of cameras, the plurality of cameras may send the shot real-time videos to the analyzing device respectively, such that the analyzing device crops the real-time images from the real-time videos. The real-time images in the embodiment of the disclosure may be any one or more of undermentioned images.

In some implementation modes, the camera components may shoot images continuously, and then the shot images are sent to the analyzing device continuously so as to analyze state change of an object in a scene within a period of time or judge events occurring within the period of time. In some other implementation modes, the camera component may be triggered by a target to shoot an image. For example, the camera component may start shooting an image responsive to an instruction that a game result comes out or game currency is placed. The analyzing device may analyze the game currency on the game table and a game controller and player at the game table in the game place based on the real-time image to determine whether actions of the game controller and/or the player conform to rules or are proper.

In some embodiments, the analyzing device in the DAS 101 may be provided with a plurality of function modules, and each function module may be configured to analyze the currently collected scene data by adopting different analyzing methods. The plurality of function modules may share the camera components in the DAS. For example, under a circumstance that the camera component includes the plurality of cameras, each function module in the plurality of function modules may analyze real-time images/real-time videos collected by part or all of cameras in the plurality of cameras, and the cameras corresponding to different function modules may be same, different or partially same.

The DAS 101 may be in communication connection with the message broker component 102. In some embodiments, the DAS 101 may send the messages sent to the management system 103 first to the message broker component 102 and then send the messages to the management system 103 through the message broker component 102. A message transfer mode between the DAS 101 and the message broker component 102 may be an issuing/subscribing mode, the DAS 101 may issue the messages with special topic to the message queue arranged in the message broker component 102, and then the message broker component 102 pulls the messages with special topics from the message queue by way of subscribing the special topic. The DAS and the message broker component may be decoupled by way of issuing/subscribing, such that the expandability of the message processing system is improved.

In some embodiments, each function module in the DAS 101 may generate messages of at least one topic. Correspondingly, message queues corresponding to different topics are set in the message broker component 102. After the DAS 101 publishes a message, the message broker component stores the message to the corresponding message queue based on the topic corresponding to the message. The message broker component 102 may further subscribe messages of part of topics to further screen messages with different topics. For example, under a circumstance that the DAS 101 includes three function modules, the first function module may generate messages of three topics A, B and C, the second function module may generate messages of three topics B, C and D, and the third function module may generate messages of two topics A and D. In the message broker component 102, four message queues may be arranged to store messages corresponding to the four topics A, B, C and C respectively. Then, the message broker component 102 may subscribe all or part of topics to further pull messages needing to be forwarded from the four message queues.

The message broker component may specifically a message-oriented middleware which may either be embedded into the DAS or the management system or be independent from the DAS and the management system. Its main function is to provide a message service between the DAS and the management system by way of decoupling.

In some embodiments, the messages generated by the DAS 101 may include a warning message or a non-warning message. Under a circumstance that the analyzing device in the DAS 101 determines that the actions of the game controller or the player are improper, for avoiding the loss of the game place or players, the DAS 101 may send target warning information to the management system 103 on the game table corresponding to the game controller or player whose actions are improper such that the management system 103 may give a warning corresponding to the target warning information to warn the game controller or the player through the game table, thereby avoiding a condition that the improper actions of the game controller or the player cause the loss of the game place or the players. In the embodiments of the disclosure, the DAS 101 may send the generated messages sent to the message broker component 102 and then forwards the messages to the management system 103 through the message broker component 102.

In some embodiments, the message broker component 102 may filter and intercept the messages that do not need to be forwarded to the management system 103 in the plurality of messages generated by the DAS 101 based on a preset configuration file and according to at least one attribute dimension of the message and the interception parameter corresponding to each attribute dimension. The configuration file may be either set by the manager based on requirements of the current scene or generated by the message broker component 102 based on a preset rule.

In some embodiments, the analyzing device in the DAS 101 may encapsulate the generated messages to obtain a message packet carrying the message type, the message identifier and the message content and send the message packet to the message queues in the message broker component 102. The message queue in the message broker component 102 may be RocketMQ, and the message broker component 102 may select at least one topic to be subscribed according to a demand.

In some embodiments, the message broker component 102 and the management system 103 may be in communication connection by adopting at least one connecting channel. Different connecting channels may forward different messages, and correspondingly, the management system 103 may further process the messages in the different connecting channels by adopting different processing modes. For example, the connecting channel between the message broker component 102 and the management system 103 may include a connecting channel for lightening indicator lights at different colors, a connecting channel for displaying the message content. The management system 103 will lighten the indicator lights corresponding to the connecting channel for the messages in the connecting channel for lightening the indicator lights at different colors according to the message content of the message and display different colors according to the message content. The management system 103 will analyze the message to obtain corresponding message content for the message in the connecting channel for displaying the message content and display the message content on a corresponding display interface.

The embodiments of the disclosure are not limited thereto. In the embodiment corresponding to FIG. 1, the DAS 101, the message broker component 102 and the management system 103 that are presented are independent respectively. However, in other embodiments, the DAS 101 and the message broker component 102 may integrated, or, the message broker component 102 and the management system 103 may be integrated.

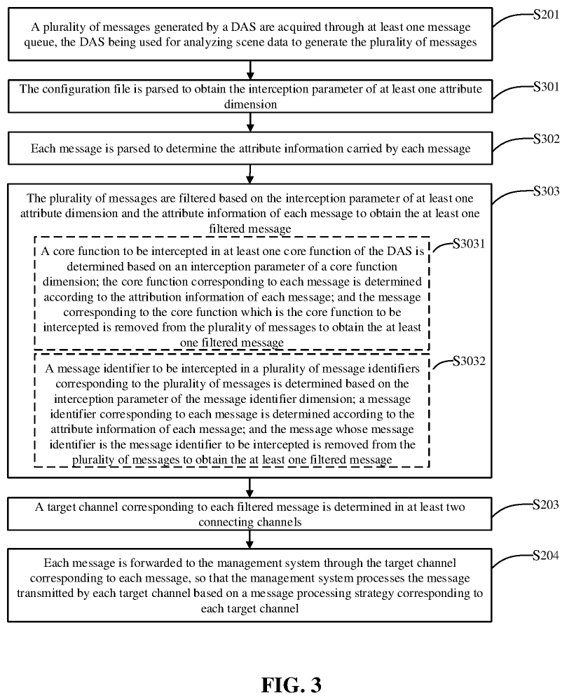

FIG. 2 is a flowchart of a message processing method provided by an embodiment of the disclosure. As shown in FIG. 2, the method is applied to a message broker component. The method includes the following operations.

At S201, a plurality of messages generated by a DAS are acquired through at least one message queue, the DAS being used for analyzing scene data to generate the plurality of messages.

In some embodiments, the message broker component is configured to forward the plurality of messages generated by the DAS to the management system. The DAS may include the analyzing device and the camera components arranged in the recreation ground. The DAS collects the scene data in the recreation ground through the camera components and analyzes the scene data through a preset analyzing method in the analyzing device, for example, to identify and/or detect an object and identify an event, to generate a corresponding message. The massage may include the warning message and/or the non-warning message. Specifically, under a circumstance that it is judged that the analyzing result meets a warning condition, for example, under a circumstance that the analyzing result that there is a cheating behavior in the game, the corresponding warning message is generated; under a circumstance that it is judged that the analyzing result does not meet the warning condition, the corresponding non-warning message is generated. The non-warning message may be the message including the analyzing result, for example, the message including the state data of the game prop of the current game scene or a notification message representing a normal game state.

In some embodiments, the camera components may acquire real-time scene data in the current game place and transmit the real-time scene data to the analyzing device. The analyzing device may analyze the real-time scene data based on a preset period to obtain a plurality of messages. Different analyzing methods may further be arranged in the DAS, and each analyzing method may include at least one message, such that the DAS may obtain the plurality of messages corresponding to the plurality of analyzing methods. The analyzing method may include, but not limited to, object analysis, attribute information identification of the object, state identification of the object, identification of relationships between the objects, analysis and/or identification of events, analysis and/or identification of change of event states and etc. Specific objects and events may be determined according to a real-time scene, for example, in a table top card game scene, the objects may include persons and/or cards participating in the game and the events include dealing cards to special persons.

It is to be noted that the messages generated by the DAS may be configured to determine whether there is abnormal conditions in the current game scene or not. The warning message represents the abnormal condition while the non-warning message may represent no abnormal condition. For example, the DAS may generate the warning message for representing abnormality of the behavior of the game controller and may further generate the message that represents whether the behavior of the player is abnormal or not. The message directing at whether there is abnormality in behavior of the game controller or not further may include the following several aspects: whether control of the game progress by the game controller is in accordance with a standard game rule or not, whether the placing position of the game prop by the game controller is in accordance with a standard placing position or not, whether the receiving quantity and the distributing quality of the game props by the game controller are in accordance with those in the standard game rule and etc. The message directing at whether the behavior of the player is abnormal or not further may include the following several aspects: whether the placing position of the game prop by the player is in accordance with a standard placing position or not, whether a gesture action of the player in the gaming process is accordance with a standard gesture rule or not, whether a using quantity of the game props or acquired data of the player are in accordance with the standard game rule and etc.

In some embodiments, after generating the plurality of messages, the DAS may encapsulate the message by adopting a preset encapsulation method for each message to obtain a message packet including the attribute information of the message and send the encapsulated message packet to the messages agent component. The attribute information of the message may include one of the follows: message type, message identifier and message content. In the embodiments below, the message is called a message for short.

In some embodiments, the message broker component may be preset with at least one message queue, and the plurality of messages generated by the DAS may be stored through the at least one message queue. The at least one message queue may serve as a message-oriented middleware through which the plurality of messages may be stored. Meanwhile, the message broker component may acquire part of or all of the plurality of messages stored in the message-oriented middleware based on the demand of the management system. Under a circumstance that the management system needs all the messages generated by the DAS, the message broker component may acquire all messages stored by the message-oriented middleware. Under a circumstance that the message broker component may acquire all messages stored by the message-oriented middleware, the message broker component may acquire part of messages in the plurality of messages stored in the message-oriented middleware.

In some embodiments, the message transfer mode between the DAS and the message broker component may be an issuing/subscribing mode, the DAS may issue the messages with at least one topic to the message queue arranged in the message broker component, and then the message broker component pulls the messages with the topic from the message queue by way of subscribing the special topic. The DAS and the message broker component may be decoupled by way of issuing/subscribing, such that the expandability of the message processing system is improved. For example, under a circumstance that messages corresponding to N topics may be generated in the DAS, the message broker component may be provided with N message queues correspondingly and each message queue corresponds to one of the N topics. Different message queues are used for storing the messages corresponding to different topics.

Based on the above embodiments of the disclosure, as the messages are transferred between the DAS and the message broker component by the issuing/subscribing mode, in a situation that the DAS needs to change its function module or add a function module, it is unnecessary for operation and maintenance staffs to modify the message broker component synchronously as the DAS and the message broker component are decoupled, such that the expandability of the message processing system is improved, and meanwhile, the development cost and the operation and maintenance cost of the system are further lowered.

Specifically, when it is needed to add an analyzing method in the DAS, the DAS may receive a configuration instruction sent by the operation and maintenance staff. The configuration instruction is used for newly adding the function module corresponding to the analyzing method in the DAS. The newly added function module may generate and issue messages with different tops based on the corresponding analyzing method, and the message broker component may subscribe the messages corresponding to each topic issued by the newly added function module by adopting the message queue corresponding to each topic without modification.

At S202, the plurality of messages are filtered based on a preset configuration file to obtain at least one filtered message, the configuration file being used for filtering out a message, which does not need to be forwarded to the management system, in the plurality of messages based on at least one attribute dimension of the message and the interception parameter corresponding to each attribute dimension.

In some embodiments, based on the requirements of the current application scene, under a circumstance that the DAS may generate a plurality of messages, the message broker component may filter the plurality of messages generated by the DAS through the preset configuration file to avoid unnecessary message push, and intercept the messages that do not need to be forwarded to the management system.

In some embodiments, each message may carry the corresponding attribute information, which may include the attribute information of the message in at least one attribute dimension. For example, the attribute information of the message may include at least one of the following: message identifier of the message, message type of the message, and function module corresponding to the message. Accordingly, in order to determine the messages that do not need to be sent to the management system, it is needed to determine the messages that need to be intercepted in a plurality of messages from at least one attribute dimension, and therefore, the configuration file may include the interception parameter corresponding to each attribute dimension. For example, the configuration file may include the interception parameters corresponding to message type dimension, message identity dimension, and message function module dimension corresponding to the message.

In some embodiments, in the process that the manager develops and debugs the DAS, the DAS may generate an error message. After the message broker component forwards the error message to the management system, the manager will receive error information, which results in unnecessary problems. In view of this, the message broker component may generate a corresponding configuration file for each error message, so as to filter the subsequent error messages generated by the DAS.

At S203, a target channel corresponding to each filtered message is determined in at least two connecting channels.

In some embodiments, the message broker component and the management system may be in communication connection through at least two connecting channels. Each connecting channel is configured to transmit a message corresponding to the connecting channel. Accordingly, after receiving the message in the connecting channel, the management system uses the message processing strategy corresponding to the connecting channel to process the message.

In some embodiments, after receiving the plurality of messages generated by the DAS through the at least one message queue, the message broker component may determine the connecting channel corresponding to the message based on the attribute information carried by each message. S202 may be implemented in the following manner for each message, based on the attribute information carried by the message, the message type of the message is acquired, and the message type includes the warning message and the non-warning message. Correspondingly, the at least two connecting channels may include at least one connecting channel configured to transfer the warning message and at least one connecting channel configured to transfer the non-warning message. Therefore, under a circumstance that the message is the warning message, at least one connecting channel configured to transfer the warning message in the at least two connecting channels may be regarded as the target channel of the message. Under a circumstance that the message is the non-warning message, at least one connecting channel configured to transfer the non-warning message in the at least two connecting channels may be regarded as the target channel of the message.

In some embodiments, after receiving the plurality of messages generated by the DAS through the at least one message queue, for each message, the message broker component may determine the target channel corresponding to the message in the at least one connecting channel based on the message queue pulling the message. A corresponding relationship between each message queue and the connecting channel is preset in the message broker component.

It is to be noted that for each message, there may be one or more the target channels corresponding to the message, that is, the same message may be merely forwarded to the management system through one connecting channel. The management system merely adopts one message processing strategy to process the message. The same message may further be forwarded to the management system through different connecting channels. The management system may adopt different message processing polices to process the message. For example, if there is one warning message, under a circumstance that the warning message is transferred to the management system through one target channel, the management system may merely process the warning message by way of generating a prompt sound; under a circumstance that the warning message is transferred to the management system through the plurality of target channels, the management system may process the warning message by way of generating a prompt sound, lightening an indicator light and displaying by a display device and etc.

In some embodiments, the connecting channel may be established based on a Websocket protocol, and the connecting channel established based on the protocol may realize full-duplex communication on a single Transmission Control Protocol (TCP) connection. Meanwhile, based on the connecting channel, the message broker component may push the message to the management system actively, and the management system may further send a special request to the message broker component. In this way, it is only needed to complete a handshake between the message broker component and the management system to establish a persistent connecting channel, and perform bidirectional data transmission based on the connecting channel.

At S204, each message is forwarded to the management system through the target channel corresponding to each message, so that the management system processes the message transmitted by each target channel based on a message processing strategy corresponding to each target channel.

In some embodiments, under a circumstance that the management system receives the message in the connecting channel for transferring the warning message, the message may be processed by adopting corresponding warning message processing strategy, for example, a corresponding warning prompt sound may be generated based on the message, a corresponding warning indicator light may further be lightened based on the message, the warning message may further be displayed on the preset display device based on the message and etc. Under a circumstance that the management system receives the message of the connecting channel for transferring the non-warning message, the message may be processed by adopting the corresponding non-warning message processing strategy, for example, the corresponding normal indicator light may be lightened based on the message and the non-warning message may further be displayed on the preset display device based on the message.

In the embodiments of the disclosure, the plurality of messages generated by the DAS is received through at least one message queue. Compared with a scheme that the DAS is directly communicated with the management system in the related art, decoupling among the subsystems of a message processing system may be realized. In a development process of the DAS or the management system, it is unnecessary to modify the other system when one of the systems is changed, such that the expandability of the system is improved while the maintenance cost of the system is lowered. Further, before the plurality of messages generated by the DAS are forwarded to the management system, the messages that do not need to be forwarded to the management system are filtered using the preset configuration files, so the message processing efficiency of the management system may be improved while system transmission bandwidth is reduced, and the effectiveness of the information obtained by the managers may also be improved.

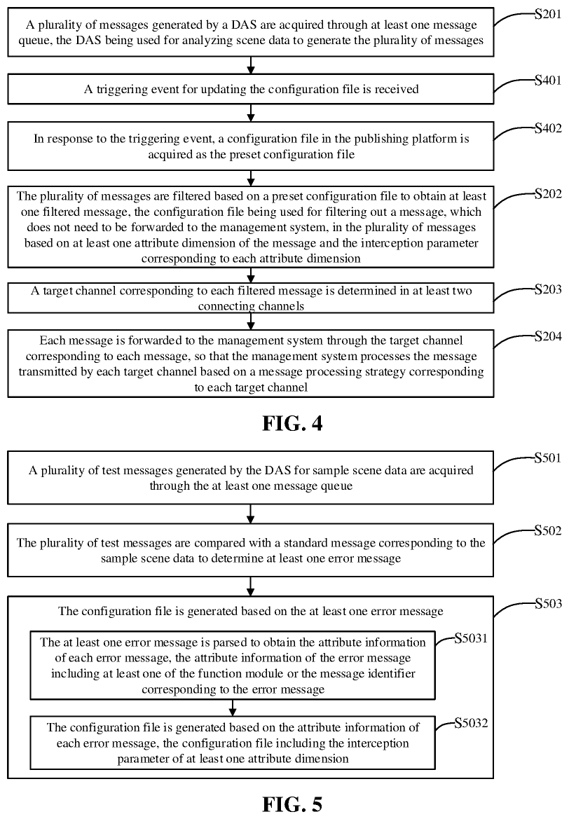

Reference is made to FIG. 3. FIG. 3 is a flowchart of a message processing method provided by an embodiment of the disclosure. Based on FIG. 2, S202 in FIG. 2 may be updated to S301 to S303, and description will be made in combination with the steps shown in FIG. 3.

At S301, the configuration file is parsed to obtain the interception parameter of at least one attribute dimension.

In some embodiments, the configuration file is used for intercepting the messages that do not need to be sent to the management system in the plurality of messages generated by the DAS. Correspondingly, in order to determine the messages that do not need to be sent to the management system, it is needed to determine from at least one attribute dimension the messages that need to be intercepted in a plurality of messages. For example, the at least one attribute dimension may include the message type dimension, the message identifier dimension, and the function module dimension corresponding to the message.

For the message type dimension, all the message types that the DAS may generate and the interception parameter of each message type may be stored in the configuration file. Under a circumstance that the message types include the warning type and the non-warning type, the corresponding interception parameters may be set in the configuration file respectively for the warning type and the non-warning type. For example, the interception parameter corresponding to the warning type is set to a first value, and the interception parameter corresponding to the non-warning type is set to a second value, the first value being used for representing that interception is required, and the second value being used for representing that interception is not required, then the corresponding configuration file is sued for intercepting the message of warning type and forwarding the message of non-warning type. In some other embodiments, the warning type represents not only that the message is the warning message but also the warning level of the message. Correspondingly, different interception parameters may also be set for different warning levels in the configuration file. For example, under a circumstance that the warning levels include the first warning level, the second warning level, and the third warning level ranked from highest to lowest, and different interception parameters may be set respectively for the first warning level, the second warning level, and the third warning level.

For the message identifier dimension, all the message identifiers set in the DAS and the interception parameter corresponding to each message identifier may be stored in the configuration file. For each message identifier, the interception parameter corresponding to the message identifier is used for determining whether to intercept the message corresponding to the message identifier.

For the function module dimension corresponding to the message, all the function modules set in the DAS and the interception parameter corresponding to each function module may be stored in the configuration file. For each function module, the interception parameter corresponding to the function module is used for determining whether to intercept all the messages generated by the function module. For example, if N function modules are set in the DAS, the interception parameter corresponding to each of the N function modules may be stored in the configuration file. In some other embodiments, only the function module needing to be intercepted and the interception parameter corresponding to the function module may be stored in the configuration file.

At S302, each message is parsed to determine the attribute information carried by each message.

In some embodiments, the attribute information carried by each message may include the attribute information of the message in the at least one attribute dimension. For example, the attribute information of the message may include at least one of the following: the message identifier of the message, the message type of the message and the function module corresponding to the message. The attribute information carried by each message may be used for determining whether the message is a message that needs to be intercepted, and the connecting channel corresponding to the message may also be determined in the process of forwarding the message to the management system.

For the message type of the message, the message type is used for determining the priority by which a casino management system processes the message. In some embodiments, the message types include the warning type and the non-warning type. Under a circumstance that the message type of the message is the warning type, a first connecting channel corresponding to the warning type in the at least two connecting channels is regarded as the target channel corresponding to the message. Under a circumstance that the message type of the message is the non-warning type, a second connecting channel corresponding to the non-warning type in the at least two connecting channels is regarded as the target channel corresponding to the message. The priority by which the management system processes the message in the first connecting channel is higher than the priority by which the management system processes the message in the second connecting channel. In some other embodiments, the warning level of the message may also be determined according to the warning type of the message. The first connecting channel corresponding to the warning level in the at least two connecting channels is regarded as the target channel corresponding to the message.

For the message identifier of the message, the message identifier is used for determining the mode in which the management system displays the message. In some embodiments, in the process of determining the target channel corresponding to the message at S203, the corresponding display mode of the message may be determined according to the message identifier of the message and a preset second mapping relationship table. The second mapping relationship table includes a mapping relationship between the message and the display mode. The display modes include at least one of the following: display screen display, indicator light display and audio display. Based on the display mode of the message, a third connecting channel corresponding to the display mode of the at least two connecting channels is regarded as the target channel corresponding to the message.

At S303, the plurality of messages are filtered based on the interception parameter of at least one attribute dimension and the attribute information of each message to obtain the at least one filtered message.

In some embodiments, for each message, whether the attribute information of the message in each attribute dimension meets an interception requirement may be determined based on the interception parameter of each attribute dimension. Under a circumstance that the attribute information of at least one attribute dimension in the message meets the interception requirement of the configuration file, it is determined that the message is a message that does not need to be forwarded to the management system, and the message is removed from the plurality of messages generated by the DAS. Under a circumstance that the attribute information of all attribute dimensions in the message does not meet the interception requirement of the configuration file, it is determined that the message is the filtered message.

Through the above embodiments of the disclosure, after the message broker component acquires a plurality of messages from the DAS, the plurality of messages may be filtered from different attribute dimensions based on different actual scenes and configuration files. For example, in a scene where the manager needs to pay attention to the messages of a warning type and/or a non-warning type, the messages may be filtered from a message type dimension, and the message broker component may be made to forward only the messages of the message type that the manager pays attention to. In a scene where the manager needs to select some display modes from display screen display, indicator light display and audio display, the messages may be filtered from the message identifier dimension, and the message broker component may be made to forward the corresponding message to the management system based on the requirements of display mode. In the process that the manager develops and debugs some function modules, to prevent a generated error message from being forwarded to the management system, the messages may be filtered from the function module dimension corresponding to the messages. Therefore, through the method disclosed in the above embodiments, not only may a plurality of messages generated by the DAS be effectively filtered, but also the messages with different attribute information may be filtered for different scenes, thereby expanding the application scope of the embodiments of the disclosure.

Reference is made to FIG. 4. FIG. 4 is a flowchart of a message processing method provided by an embodiment of the disclosure. Based on any above embodiment, taking FIG. 2 as an example, the method further includes S401 to S402 after S201, and description will be made in combination with the steps shown in FIG. 4.

At S401, a triggering event for updating the configuration file is received.

In some embodiments, there is a preset configuration file stored in the message broker component. The preset configuration file may be either manually uploaded by the manager during the initialization of the message broker component or pulled from the publishing platform corresponding to the message broker component. In the process of filtering the plurality of messages generated by the DAS based on the preset configuration file, the trigger event for updating the configuration file is received. The trigger event is used for instructing the message broker component to acquire the latest configuration file and replace the previously stored configuration file with the latest configuration file.

At S402, in response to the triggering event, a configuration file in the publishing platform is acquired as the preset configuration file.

The publishing platform may be configured to publish the message broker component, the DAS and the management system. For example, when the user needs to change the configuration file stored in the message broker component, a configuration instruction corresponding to the configuration file may be sent to the publishing platform, and the publishing platform generates a new configuration file based on the configuration instruction and generates the trigger event. After receiving the triggering event, the message broker component may acquire the latest configuration file from the publishing platform. When the function modules need to be added, deleted, modified, or queried in the DAS, the user may log in to the publishing platform, and publish new function modules and delete/modify/query the previous function modules according to actual requirements.

In some embodiments, the triggering event includes at least one of the following: the message broker component is started; and the publishing platform receives the user's configuration instruction for the configuration file.

During the startup of the message broker component, in order to ensure that the version of the preset configuration file stored locally is up to date, the message broker component needs to acquire the configuration file from the publishing platform as the preset configuration file. In addition, if the publishing platform receives the user's configuration instruction for the configuration file, which indicates that the configuration file in the publishing platform has changed, then the message broker component needs to acquire the configuration file in the publishing platform as the preset configuration file. In addition, the message broker component may also acquire, based on a preset update frequency, the configuration file from the publishing platform as the preset configuration file.

Through the above embodiments of the disclosure, the message broker component may acquire, in response to the triggering event for updating the configuration file, the configuration file in the publishing platform as the preset configuration file. Therefore, a filtering rule of the message broker component for the plurality of messages generated by the DAS may be changed as user needs change, which not only improves the flexibility of a message filtering scheme, but also improves the quality of the messages received by the management system.

Reference is made to FIG. 5. FIG. 5 is a flowchart of a message processing method provided by an embodiment of the disclosure, and description will be made in combination with the steps shown in FIG. 5.

At S501, a plurality of test messages generated by the DAS for sample scene data are acquired through the at least one message queue.

In some embodiments, the message broker component may also analyze whether the message generated by the DAS is correct, and then generate the corresponding configuration file based on the error message, so as to prevent the error message from being forwarded to the management system and causing the manager of the management system to receive the error message. In the embodiment, the DAS may generate the corresponding configuration file in response to a test event. The test event may be initiated by the manager or automatically at a preset frequency.

For a test event, the DAS may analyze the sample scene data. The DAS may include a plurality of function modules, and each function module corresponds to part or all of the sample scene data. Correspondingly, the DAS (multiple function modules) may generate a plurality of test messages corresponding to the sample scene data. It is to be noted that during testing, the DAS analyzes both the sample scene data and the scene data collected in real time. In order to distinguish the messages generated by different scene data, test identifiers may be added to a plurality of test messages corresponding to the sample scene data.

At S502, the plurality of test messages is compared with a standard message corresponding to the sample scene data to determine at least one error message.

In some embodiments, a corresponding standard message is set for the sample scene data. The standard message is a correct message set by the manager based on the sample scene data and the function of the DAS. For example, if the DAS is set as “if X is greater than 1, a warning message X1 is sent, or else a non-warning message X2 is sent”, and the corresponding sample scene data is “X=4”, then the corresponding correct message is “warning message X1”.

In some embodiments, a plurality of test messages acquired may intersect with the standard message corresponding to the sample scene data, and the message in the intersection is considered as the correct messages generated by the DAS. At least one of the above error messages may include the message sent by mistake in the plurality of test messages and/or the missed message in the standard message. The message sent by mistake is any other message in the plurality of test messages except the correct message in the intersection. The missed message is any other message in the standard message except the correct message in the intersection.

For example, if the standard message corresponding to the sample scene data includes M1, M2, M3, and M4, and the test message generated by the DAS based on the sample scene data includes M5, M2, M3, and M4, then the M1 is the missed message, and the M5 is the message sent by mistake.

At S503, the configuration file is generated based on the at least one error message.

In some embodiments, the generation of the configuration file based on the at least one error message may be achieved through S5031 to S5032.

At S5031, the at least one error message is parsed to obtain the attribute information of each error message, the attribute information of the error message including at least one of the followings: the function module or the message identifier corresponding to the error message.

At S5032, the configuration file is generated based on the attribute information of each error message, the configuration file including the interception parameter of at least one attribute dimension.

In some embodiments, for each error message, the function module corresponding to each error message is acquired, and the interception parameter corresponding to the function module dimension is generated based on the function module corresponding to each error message. That is, the interception parameter corresponding to the function module where the error message occurs is set to the first value in the above embodiment. In some other embodiments, the number of error messages corresponding to each function module may also be counted, and if the number of messages exceeds a preset threshold, the interception parameter of the corresponding function module is set to the first value.

In some embodiments, for each error message, the message identifier corresponding to each error message is acquired, and the interception parameter corresponding to the message identifier dimension is generated based on the message identifier corresponding to each error message. That is, the interception parameter corresponding to the message identifier where the error message occurs is set to the first value in the above embodiment. In some other embodiments, the number of error messages corresponding to each message identifier may also be counted, and if the number of messages exceeds a preset threshold, the interception parameter of the corresponding message identifier is set to the first value.

It is to be noted that the preset threshold may be adjusted according to an accuracy requirement. The higher the accuracy required, the smaller the preset threshold; the lower the accuracy required, the greater the preset threshold.

Through the above embodiments of the disclosure, the message broker component may generate the test messages for the sample scene data based on the DAS, count the attribute information of the error message generated by the DAS, and then generate the corresponding configuration file based on the attribute information of the error message. Therefore, the generated configuration file may adaptively filter the error message generated by the DAS, which improves message passing efficiency.

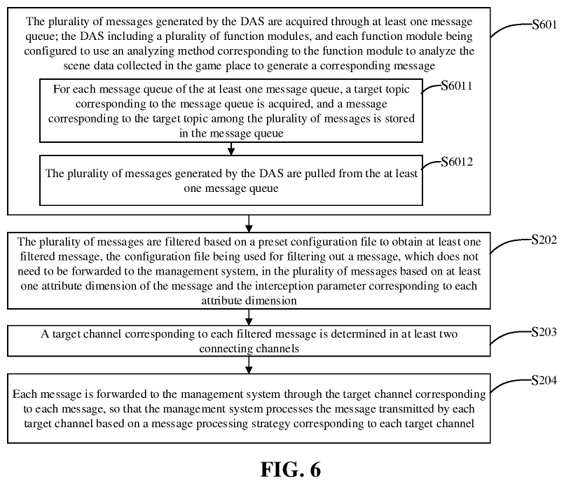

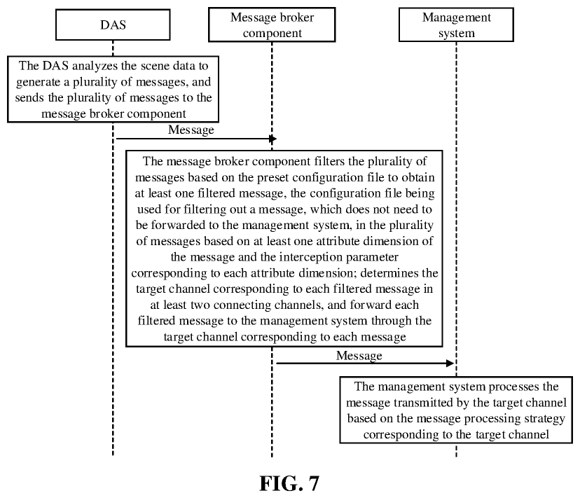

Reference is made to FIG. 6. FIG. 6 is a flowchart of a message processing method provided by an embodiment of the disclosure. Based on FIG. 2, S201 in FIG. 2 may be updated to S601, and S202 may be updated to S602, and description will be made in combination with the steps shown in FIG. 6.

At S601, the plurality of messages generated by the DAS are acquired through at least one message queue; the DAS including a plurality of function modules, and each function module being configured to use an analyzing method corresponding to the function module to analyze the scene data collected in the game place to generate a corresponding message.

In some embodiments, the DAS includes a plurality of function modules, and each function module is configured to use the analyzing method corresponding to the function module to analyze the scene data collected in the game place to generate the corresponding message. The message is used for indicating whether there is an abnormal event in the game place or not. Further, different function modules may use different analyzing methods to analyze the scene data collected in the game place.

It is to be noted that the plurality of function modules in the DAS are not analysis modules realized through hardware but software in form of program and plug-in formed based on different analysis algorithms. These function modules are logical, such that the function modules may be combined at will or may be further split according to the implemented functions.

In some embodiments, the plurality of messages generated by the DAS may be acquired through at least one message queue from S6011 to S6012.

At S6011, for each message queue of the at least one message queue, a target topic corresponding to the message queue is acquired, and a message corresponding to the target topic among the plurality of messages is stored in the message queue.

At S6012, the plurality of messages generated by the DAS are pulled from the at least one message queue.

In some embodiments, the plurality of messages generated by the DAS may also be pulled from the at least one message queue in the following way: at least one topic to be pulled is determined based on the configuration file; and the message is pulled from the message queue corresponding to each topic to be pulled based on the at least one topic to be pulled.

The message broker component may determine the message the manager needs based on at least one topic to be pulled stored in the configuration file, and then may pull the message from the message queue corresponding to each topic to be pulled. In some other embodiments, for the message queue corresponding to the topic not to be pulled in at least one message queue, the message broker component may delete the messages in the message queue directly.

Through the above embodiments of the disclosure, the message that the manager currently needs to pull may be determined through at least one topic to be pulled set in the configuration file, and then only the message that the manager needs may be pulled in the process of pulling messages. In this way, not only may the plurality of messages generated by the DAS be filtered from the dimension of service type, but also the process of the message broker component parsing the pulled messages may be saved, thereby reducing the system calculation pressure of the message broker component.

The embodiments of the disclosure also provide a message processing method, which is applied to the message processing system, as shown in FIG. 7. FIG. 7 is a flowchart of a message processing method provided by an embodiment of the disclosure, and description will be made in combination with the steps shown in FIG. 7.

At S701, the DAS analyzes the scene data to generate a plurality of messages, and sends the plurality of messages to the message broker component.

At S702, the message broker component filters the plurality of messages based on the preset configuration file to obtain at least one filtered message, the configuration file being used for filtering out a message, which does not need to be forwarded to the management system, in the plurality of messages based on at least one attribute dimension of the message and the interception parameter corresponding to each attribute dimension, determine the target channel corresponding to each filtered message in at least two connecting channels, and forward each filtered message to the management system through the target channel corresponding to each message.

At S703, the management system processes the message transmitted by the target channel based on the message processing strategy corresponding to the target channel.

In the embodiments of the disclosure, the plurality of messages generated by the DAS is received through at least one message queue. Compared with a scheme that the DAS is directly communicated with the management system in the related art, decoupling among the subsystems of a message processing system may be realized. In a development process of the DAS or the management system, it is unnecessary to modify the other system when one of the systems is changed, such that the expandability of the system is improved while the maintenance cost of the system is lowered. In addition, because different connecting channels are set for different types of messages in the message broker component and the management system, it is convenient for the management system to set different message processing strategies for different connecting channels, and when the management system receives a message, it can directly process the message according to the message processing strategy corresponding to the target channel for transmitting the message, which may improve the message processing efficiency. In addition, before the plurality of messages generated by the DAS are forwarded to the management system, the messages that do not need to be forwarded to the management system are filtered using the preset configuration files, so the message processing efficiency of the management system may be improved while system transmission bandwidth is reduced, and the effectiveness of the information obtained by the managers may also be improved.

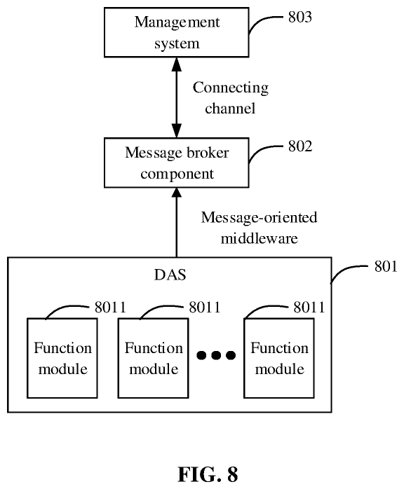

Description on an exemplary application of the embodiment of the disclosure in an actual application scenario will be made below. Reference is made to FIG. 8. FIG. 8 is a schematic diagram of system architecture of a message processing system provided by an embodiment of the disclosure. The DAS 801 and the message broker component 802 transfer the messages through at least one message queue of RocketMQ (message-oriented middleware), and the messages are transferred between the message broker component 802 and the management system 803 through WebSocket (connecting channel).

In some embodiments, the DAS includes a plurality of function modules (core-function) 8011. The function modules 8011 are not analysis modules realized through hardware but software in form of program and plug-in formed based on different analysis algorithms. These function modules are logical, such that the function modules may be combined at will or may be further split according to the implemented functions.

In some embodiments, each function module operates the corresponding service processing logic and generates a message, and the message may include the non-warning message and the warning message. Then, the function module may send the message needing to be pushed to the CMS system to the message queue of RocketMQ, and the message broker component (msg-broker-service) forwards the non-warning message and/or the warning message finally to the CMS system through the WebSocket channel by subscribing the messages of the RocketMQ message queue. The DAS may send data in real time to the management system by way of WebSocket. It is to be noted that the main reason of using a WebSocket interaction mode rather than Http to communicate is that it is unnecessary to establish a connection between networks every time, it is only needed to establish a connection at one time to push the data in real time, thereby reducing the delay overhead caused by network connection.

In order to acquire more comprehensive scene data, in the game place, the DAS may adopt different function modules for different types of scene data, and the different function modules correspond to different service processing logics, for example, the service logic corresponding to a core function module for detecting a card dealing sequence includes judging whether the card dealing sequence is in accordance with the game rule or not according to the sequence of paper cards, and the core function module for detecting a game currency placing logic of the player includes judging whether the player is in a region allowed to place the game currency and/or place the game currency in the game stage according to an association relationship between the hand of the player and the game currency and the position of the game currency. According to the embodiment of the disclosure, the message broker component is arranged between the DAS and the management system by establishing the message broker component (msg-broker-service), and further, the WebSocket messages sent by all the function modules are collected uniformly through the message broker component and are forwarded to the downstream management system. In some embodiments, the embodiments of the disclosure may further classify the messages send out: warning messages and non-warning messages, and messages of different types are pushed to different WebSocket channels. Via the abovementioned embodiments, it is only needed to establish a connection between the CMS system and msg-broker-service and it is not needed to establish an independent WebSocket connection for each function module. Under a circumstance that the function module is additionally arranged, it is not needed to modify an existing WebSocket program of the CMS system, such that the expandability of the system is improved.

In the above scene, the non-warning messages and/or the warning messages are generated incorrectly due to the low algorithm accuracy in the development/test process of the function modules, which leads to error message push. Therefore, under a circumstance that the algorithm accuracy of some function module does not meet user requirements, the user wants to disable a message push service of these function modules before they meet the target accuracy, so that the error warning messages and/or non-warning messages received by the CMS may be reduced. In addition, after the development/test process is completed and the accuracy meets the user requirements, the message push service of the functional modules disabled previously is enabled to ensure the stability of the whole system.

In some embodiments, a corresponding configuration file (application.yml) may be preset in the message broker component. The configuration file includes a configuration parameter (functionSwitch) of the function module that needs to be added with a switch. The configuration parameter corresponding to each function module is used for determining whether the message broker component pushes the message generated by the function module to the management system. The configuration file in the message broker component may be modified through the publishing platform (Backend platform). Also, after the configuration file is modified, the message broker component is restarted and run to pull the latest configuration file again.

In some embodiments, the message broker component determines whether the message corresponding to each function module needs to be sent to the WebSocket channel by reading the configuration parameter of each function module in the configuration file, and then controls whether the message is forwarded to the management system. Correspondingly, if the configuration parameter of a certain function module represents that the switch is off, the message broker component will not push the message received from the function module to the WebSocket channel, and the WebSocket channel connected to the CMS system will not receive the message of the function module.

FIG. 9 is a composition structure diagram of a message processing apparatus provided by an embodiment of the disclosure. As shown in FIG. 9, the message processing apparatus 900 includes an acquisition unit 901, a filtering unit 902, a determination unit 903 and a forwarding unit 904.

The acquisition unit 901 is configured to acquire a plurality of messages generated by the DAS through at least one message queue, the DAS being used for analyzing the scene data to generate the plurality of messages.

The filtering unit 902 is configured to filter the plurality of messages based on the preset configuration file to obtain at least one filtered message, the configuration file being used for filtering out a message, which does not need to be forwarded to the management system, in the plurality of messages based on the attribute dimension of the message and the interception parameter corresponding to each attribute dimension.

The determination unit 903 is configured to determine the target channel corresponding to each message in at least two connecting channels.

The forwarding unit 904 is configured to forward each message to the management system through the target channel corresponding to each message, so that the management system processes the message transmitted by each target channel based on the message processing strategy corresponding to each target channel.

In some embodiments, the message processing apparatus is applied to a message broker system, and the message broker system is configured to forward the plurality of messages generated by the DAS to the management system. The DAS includes a plurality of function modules. Each function module is configured to use an analyzing method corresponding to the function module to analyze the scene data collected in the game place to generate a corresponding message. The message is used for indicating whether there is an abnormal event in the game place or not. The management system is configured to display the plurality of messages forwarded by the message broker system to the game controller.

In some embodiments, the DAS further includes a camera component arranged in the game place, the camera component being configured to collect the scene data in the game place.

In some embodiments, the filtering unit 902 is further configured to parse the configuration file to obtain the interception parameter of at least one attribute dimension, parse each message to determine the attribute information carried by each message, and filter the plurality of messages based on the interception parameter of at least one attribute dimension and the attribute information of each message to obtain the at least one filtered message.

In some embodiments, the interception parameter of at least one attribute dimension includes the interception parameter of the function module dimension corresponding to the message. The filtering unit 902 is further configured to determine the function module to be intercepted in at least one function module of the DAS based on the interception parameter of the function module dimension, determine the function module corresponding to each message according to the attribute information of each message, and remove the message corresponding to the function module which is the function module to be intercepted from the plurality of messages to obtain the at least one filtered message.

In some embodiments, the interception parameter of at least one attribute dimension includes the interception parameter of the message identifier dimension. The filtering unit 902 is further configured to determine the message identifier to be intercepted in a plurality of message identifiers corresponding to the plurality of messages based on the interception parameter of the message identifier dimension, determine the message identifier corresponding to each message according to the attribute information of each message, and remove the message whose message identifier is the message identifier to be intercepted from the plurality of messages to obtain the at least one filtered message.

In some embodiments, the message processing apparatus 900 also includes a pulling unit and a configuration unit.

In some embodiments, the pulling unit is configured to receive the triggering event for updating the configuration file, and in response to the triggering event, acquire the configuration file in the publishing platform as the preset configuration file. The triggering event includes at least one of the following: the message broker component is started; and the publishing platform receives the user's configuration instruction for the configuration file.

In some embodiments, the configuration unit is configured to acquire a plurality of test messages generated by the DAS for sample scene data through the at least one message queue, compare the plurality of test messages with the standard message corresponding to the sample scene data to determine at least one error message, and generate the configuration file based on the at least one error message.

In some embodiments, the configuration unit is further configured to parse the at least one error message to obtain the attribute information of each error message, the attribute information of the error message including at least one of the followings: the function module or the message identifier corresponding to the error message, and generate the configuration file based on the attribute information of each error message, the configuration file including the interception parameter of at least one attribute dimension.

In some embodiments, the DAS includes a plurality of function modules, and different function modules analyze the scene data through different analyzing methods to generate the message corresponding to at least one topic. The acquisition unit 901 is further configured to acquire the target topic corresponding to the message queue for each message queue of the at least one message queue, store a message corresponding to the target topic among the plurality of messages in the message queue, and pull the plurality of messages generated by the DAS from the at least one message queue.

In some embodiments, the acquisition unit 901 is further configured to determine at least one topic to be pulled based on the configuration file, and pull the message from the message queue corresponding to each topic to be pulled based on the at least one topic to be pulled.

The above descriptions about the apparatus embodiments are similar to descriptions about the method embodiments and beneficial effects similar to those of the method embodiments are achieved. Technical details undisclosed in the apparatus embodiments of the disclosure may be understood with reference to the descriptions about the method embodiments of the disclosure.

It is to be noted that, in the embodiments of the disclosure, when being implemented in form of software function module and sold or used as an independent product, the message processing method may also be stored in a computer-readable storage medium. Based on such an understanding, the embodiments of the disclosure substantially or parts making contributions to the related art may be embodied in form of software product, and the computer software product is stored in a storage medium, including a plurality of instructions configured to enable a device to execute all or part of the method in each embodiment of the disclosure. The storage medium includes: various media capable of storing program codes such as a U disk, a mobile hard disk, a Read Only Memory (ROM), a magnetic disk or an optical disk. Therefore, the embodiments of the disclosure are not limited to any target hardware and software combination.

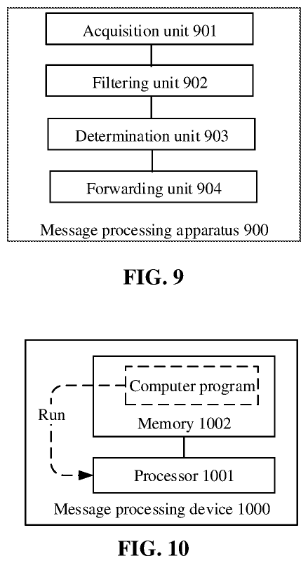

FIG. 10 is a schematic diagram of a hardware entity of a message processing device provided by an embodiment of the disclosure. As shown in FIG. 10, the hardware entity of the message processing device 1000 includes a processor 1001 and a memory 1002. The memory 1002 stores a computer program capable of running in the processor 1001. The processor 1001 executes the program to implement the steps in the method of any abovementioned embodiment.

The memory 1002 stores a computer program capable of running on the processor. The memory 1002 is configured to store an instruction and application executable for the processor 1001, may also cache data (for example, image data, video data, voice communication data and video communication data) to be processed or having been processed by each module in the processor 1001 and the message processing device 1000, and may be implemented through a flash or a Random Access Memory (RAM).

The processor 1001 implements, when executing the program, the steps of any above message processing method. The processor 1001 usually controls an overall operation of the message processing device 1000.

The embodiments of the disclosure provide a computer storage medium, which stores one or more than one program. The one or more than one program may be executed by one or more than one processor to implement the steps of the message processing method in any above embodiment.

It is to be pointed out here that the above descriptions about the storage medium and device embodiments are similar to descriptions about the method embodiments and beneficial effects similar to those of the method embodiments are achieved. Technical details undisclosed in the storage medium and device embodiments of the disclosure may be understood with reference to the descriptions about the method embodiments of the disclosure.

The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a controller, a microcontroller, or a microprocessor. It can be understood that other electronic devices may also be configured to realize functions of the processor, and no specific limits are made in the embodiments of the disclosure.

The computer storage medium/memory may be a memory such as a ROM, a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disk, or a Compact Disc Read-Only Memory (CD-ROM), or may be any terminal including one or any combination of the abovementioned memories, such as a mobile phone, a computer, a tablet device, and a personal digital assistant.

It is to be understood that “one embodiment” or “an embodiment” or “the embodiment of the disclosure” or “the abovementioned embodiment” or “some embodiments” mentioned in the whole specification means that target features, structures or characteristics related to the embodiment are included in at least one embodiment of the disclosure. Therefore, “in one embodiment” or “in an embodiment” or “the embodiment of the disclosure” or “the abovementioned embodiment” or “some embodiments” appearing everywhere in the whole specification does not always refer to the same embodiment. In addition, these target features, structures or characteristics may be combined in one or more embodiments freely as appropriate. It is to be understood that, in various embodiments of the application, a magnitude of a sequence number of each process does not mean an execution sequence and the execution sequence of each process should be determined by its function and an internal logic and should not form any limit to an implementation process of the embodiments of the application. The sequence numbers of the embodiments of the application are adopted not to represent superiority-inferiority of the embodiments but only for description.

If not specified, when the message processing device executes any step in the embodiments of the disclosure, the processor of the message processing device executes the step. Unless otherwise specified, the sequence of execution of the following steps by the message processing device is not limited in the embodiments of the disclosure. In addition, the same method or different methods may be used to process data in different embodiments. It is also to be noted that any step in the embodiments of the disclosure may be executed independently by the message processing device, namely the message processing device may execute any step in the abovementioned embodiments independent of execution of the other steps.

In some embodiments provided by the application, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the embodiments.

In addition, each functional unit in each embodiment of the disclosure may be integrated into a processing unit, each unit may also serve as an independent unit and two or more than two units may also be integrated into a unit. The integrated unit may be implemented in a hardware form and may also be implemented in form of hardware and software functional unit.

The methods disclosed in some method embodiments provided in the disclosure may be freely combined without conflicts to obtain new method embodiments.

The characteristics disclosed in some product embodiments provided in the disclosure may be freely combined without conflicts to obtain new product embodiments.

The characteristics disclosed in some method or device embodiments provided in the disclosure may be freely combined without conflicts to obtain new method embodiments or device embodiments.

Those of ordinary skill in the art should know that all or part of the steps of the method embodiment may be implemented by related hardware instructed through a program, the program may be stored in a computer-readable storage medium, and the program is executed to execute the steps of the method embodiment. The storage medium includes: various media capable of storing program codes such as a mobile storage device, a ROM, a magnetic disk or a compact disc.

Or, when being implemented in form of software function module and sold or used as an independent product, the integrated unit of the application may also be stored in a computer-readable storage medium. Based on such an understanding, the embodiments of the disclosure substantially or parts making contributions to the related art may be embodied in form of a software product. The computer software product is stored in a storage medium, including a plurality of instructions configured to cause a computer device (which may be a personal computer, a message processing device, a network device or the like) to execute all or part of the method in each embodiment of the disclosure. The storage medium includes: various media capable of storing program codes such as a mobile hard disk, a ROM, a magnetic disk or a compact disc.

In the embodiments of the disclosure, the descriptions about the same steps and the same contents in different embodiments may refer to those in the other embodiments. In the embodiments of the disclosure, term “and” does not influence the sequence of the steps.

The above are only the specific implementation modes of the disclosure and not intended to limit the protection scope of the disclosure; any change or replacement that those skilled in the art can think of easily in the scope of technologies disclosed by the disclosure shall fall within the protection scope of the disclosure. Therefore, the scope of protection of the disclosure shall be subject to the scope of protection of the claims.

What is claimed is:

1. A message processing method, comprising:
acquiring a plurality of messages generated by a Data Analyzing System (DAS) through at least one message queue, the DAS being used for analyzing scene data to generate the plurality of messages;
filtering the plurality of messages based on a preset configuration file to obtain at least one filtered message, the configuration file being used for filtering out a message, which does not need to be forwarded to a management system, in the plurality of messages based on at least one attribute dimension of the message and an interception parameter corresponding to each attribute dimension;
determining a target channel corresponding to each filtered message in at least two connecting channels; and
forwarding the each filtered message to the management system through the target channel corresponding to the each filtered message, enabling the management system to process a message transmitted by each target channel based on a message processing strategy corresponding to the each target channel.

2. The method of claim 1, wherein the method is applied to a message broker component, the message broker component being configured to filter the plurality of messages generated by the DAS and forward the filtered message to the management system, wherein
the DAS comprises a plurality of function modules, each function module being configured to analyze scene data collected in a game place by adopting an analyzing method corresponding to the each function module to generate a corresponding message; the message is used for indicating whether there is an abnormal event in the game place or not;
the management system is configured to display the filtered message forwarded by the message broker component to a game controller.

3. The method of claim 2, wherein the DAS further comprises a camera component arranged in the game place, the camera component being configured to collect the scene data in the game place.

4. The method of claim 2, wherein filtering the plurality of messages based on the preset configuration file to obtain the at least one filtered message comprises:
parsing the configuration file to obtain an interception parameter of at least one attribute dimension;
parsing the each message to determine attribute information carried by the each message; and
filtering the plurality of messages based on the interception parameter of the at least one attribute dimension and the attribute information of the each message to obtain the at least one filtered message.

5. The method of claim 4, wherein the interception parameter of the at least one attribute dimension comprises the interception parameter of a function module dimension corresponding to the message; wherein filtering the plurality of messages based on the interception parameter of the at least one attribute dimension and the attribute information of the each message to obtain the at least one filtered message comprises:
determining a function module to be intercepted in at least one function module of the DAS based on the interception parameter of the function module dimension;
determining the function module corresponding to the each message according to the attribute information of the each message; and
removing the message corresponding to the function module which is the function module to be intercepted from the plurality of messages to obtain the at least one filtered message.

6. The method of claim 4, wherein the interception parameter of at least one attribute dimension comprises the interception parameter of a message identifier dimension; wherein filtering the plurality of messages based on the interception parameter of the at least one attribute dimension and the attribute information of the each message to obtain the at least one filtered message comprises:
determining a message identifier to be intercepted in a plurality of message identifiers corresponding to the plurality of messages based on the interception parameter of the message identifier dimension;
determining a message identifier corresponding to the each message according to the attribute information of the each message; and
removing the message whose message identifier is the message identifier to be intercepted from the plurality of messages to obtain the at least one filtered message.

7. The method of claim 2, further comprising:
receiving a triggering event for updating the configuration file; and
in response to the triggering event, acquiring a configuration file in a publishing platform as the preset configuration file.

8. The method of claim 7, wherein the triggering event comprises at least one of:
the message broker component is started; or
the publishing platform receives a configuration instruction of a user for the configuration file.

9. The method of claim 1, further comprising:
acquiring, through the at least one message queue, a plurality of test messages generated by the DAS for sample scene data;
comparing the plurality of test messages with a standard message corresponding to the sample scene data to determine at least one error message; and
generating the configuration file based on the at least one error message.

10. The method of claim 9, wherein generating the configuration file based on the at least one error message comprises:
parsing the at least one error message to obtain attribute information of each error message, the attribute information of the error message comprising at least one of a function module or a message identifier corresponding to the error message; and
generating the configuration file based on the attribute information of the each error message, the configuration file comprising the interception parameter of at least one attribute dimension.

11. The method of claim 3, wherein acquiring, through the at least one message queue, the plurality of messages generated by the DAS comprises:
for each message queue of the at least one message queue, acquiring a target topic corresponding to the message queue, and storing a message corresponding to the target topic among the plurality of messages in the message queue; and
pulling the plurality of messages generated by the DAS from the at least one message queue.

12. The method of claim 11, wherein pulling the plurality of messages generated by the DAS from the at least one message queue comprises:
determining at least one topic to be pulled based on the configuration file; and
pulling the message from the message queue corresponding to each topic to be pulled based on the at least one topic to be pulled.

13. A message processing device, comprising a memory and a processor;
wherein the memory stores a computer program capable of running on the processor,
wherein when executing the computer program, the processor is configured to:
acquire a plurality of messages generated by a Data Analyzing System (DAS) through at least one message queue, the DAS being used for analyzing scene data to generate the plurality of messages;
filter the plurality of messages based on a preset configuration file to obtain at least one filtered message, the configuration file being used for filtering out a message, which does not need to be forwarded to a management system, in the plurality of messages based on at least one attribute dimension of the message and an interception parameter corresponding to each attribute dimension;
determine a target channel corresponding to each filtered message in at least two connecting channels; and
forward the each filtered message to the management system through the target channel corresponding to the each filtered message, enabling the management system to process a message transmitted by each target channel based on a message processing strategy corresponding to the each target channel.

14. The message processing device of claim 13, wherein when filtering the plurality of messages based on the preset configuration file to obtain the at least one filtered message, the processor is configured to:
parse the configuration file to obtain an interception parameter of at least one attribute dimension;
parse the each message to determine attribute information carried by the each message; and
filter the plurality of messages based on the interception parameter of the at least one attribute dimension and the attribute information of the each message to obtain the at least one filtered message.

15. The message processing device of claim 14, wherein the interception parameter of the at least one attribute dimension comprises the interception parameter of a function module dimension corresponding to the message; wherein when filtering the plurality of messages based on the interception parameter of the at least one attribute dimension and the attribute information of the each message to obtain the at least one filtered message, the processor is configured to:
determine a function module to be intercepted in at least one function module of the DAS based on the interception parameter of the function module dimension;
determine the function module corresponding to the each message according to the attribute information of the each message; and
remove the message corresponding to the function module which is the function module to be intercepted from the plurality of messages to obtain the at least one filtered message.

16. The message processing device of claim 14, wherein the interception parameter of at least one attribute dimension comprises the interception parameter of a message identifier dimension; wherein when filtering the plurality of messages based on the interception parameter of the at least one attribute dimension and the attribute information of the each message to obtain the at least one filtered message, the processor is configured to:
determine a message identifier to be intercepted in a plurality of message identifiers corresponding to the plurality of messages based on the interception parameter of the message identifier dimension;
determine a message identifier corresponding to the each message according to the attribute information of the each message; and
remove the message whose message identifier is the message identifier to be intercepted from the plurality of messages to obtain the at least one filtered message.

17. The message processing device of claim 14, wherein the processor is further configured to:
receive a triggering event for updating the configuration file; and
in response to the triggering event, acquire a configuration file in a publishing platform as the preset configuration file.

18. The message processing device of claim 13, wherein the processor is further configured to:
acquire, through the at least one message queue, a plurality of test messages generated by the DAS for sample scene data;
compare the plurality of test messages with a standard message corresponding to the sample scene data to determine at least one error message; and
generate the configuration file based on the at least one error message.

19. The message processing device of claim 18, wherein when generating the configuration file based on the at least one error message, the processor is configured to:
parse the at least one error message to obtain attribute information of each error message, the attribute information of the error message comprising at least one of a function module or a message identifier corresponding to the error message; and
generate the configuration file based on the attribute information of the each error message, the configuration file comprising the interception parameter of at least one attribute dimension.

20. A computer storage medium, storing one or more computer programs, wherein the one or more computer programs are executed by one or more processors to:
acquire a plurality of messages generated by a Data Analyzing System (DAS) through at least one message queue, the DAS being used for analyzing scene data to generate the plurality of messages;
filter the plurality of messages based on a preset configuration file to obtain at least one filtered message, the configuration file being used for filtering out a message, which does not need to be forwarded to a management system, in the plurality of messages based on at least one attribute dimension of the message and an interception parameter corresponding to each attribute dimension;
determine a target channel corresponding to each filtered message in at least two connecting channels; and
forward the each filtered message to the management system through the target channel corresponding to the each filtered message, enabling the management system to process a message transmitted by each target channel based on a message processing strategy corresponding to the each target channel.
